(19) United States
(12) Patent Application Publication
(10) Pub. No.: US 2022/0376921 A1
(43) Pub. Date: Nov. 24, 2022

(54) BLOCKCHAIN AUTHENTICATOR FOR DYNAMIC SPECTRUM SHARING AND BLOCKCHAIN CYBERSECURITY SERVICES

(71) Applicant: AT&T Mobility II LLC, Atlanta, GA (US)

(72) Inventor: Arturo Maria, Bellevue, WA (US)

(21) Appl. No.: 17/326,634

(22) Filed: May 21, 2021

(51) Int. Cl. H04L 9/32; H04W 72/04; H04W 12/06; H04W 12/106

(52) U.S. Cl. CPC H04L 9/3239; H04W 72/0453; H04W 12/06; H04W 12/106; H04W 16/14

(57) ABSTRACT

Blockchain algorithms may be used to authenticate frequency changes and create a log of when DSS frequencies were modified. This approach may allow for a secure log that will detail the history of when frequencies were changed by the frequency owner or a delegated third party to perform spectrum access sharing (SAS) services.

### BACKGROUND

The Department of Defense owns a vast amount of radio frequency (RF) spectrum that is used for a variety of systems. An example is the Citizens Broadband Radio Service (CBRS) spectrum which is shared with radar systems. Dynamic spectrum sharing (DSS) is used to share radio frequencies previously allocated to one entity. In 2012, the FCC started the process of partially releasing and allocating the 3.5 GHz-3.7 GHz frequencies previously owned by the Department of Defense when it created CBRS. Under the CBRS architecture, DSS is performed by informing carriers and CBRS users of a frequency change via a spectrum access sharing system (e.g., SAS system). In the present architecture for Dynamic Spectrum Sharing (DSS) there is little or weak authentication for communicating changes in frequencies.

This background information is provided to reveal information believed by the applicant to be of possible relevance. No admission is necessarily intended, nor should be construed, that any of the preceding information constitutes prior art.

### SUMMARY

Disclosed herein is the use of blockchain algorithms to authenticate frequency changes and create a log of when DSS frequencies were modified. This approach may allow for a secure log that will detail the history of when frequencies were changed by the frequency owner or a delegated third party to perform spectrum access sharing (SAS) services. This may be significant for the next few years as frequencies currently owned by the Department of Defense are expected to be released to the public and used via dynamic spectrum sharing (DSS) facilities. The addition of secure authentication and logging services may enhance the confidence in frequency allocation decisions and commercialization of these services. Various offers may be introduced to manage the blockchain authentication process and position itself in a controlling or monetization posture.

In an example, a device may include a processor and a memory coupled with the processor that effectuates operations. The operations may include receiving an indication of an event, wherein the event comprises detection of radio waves active in a first frequency; based on the event, providing instructions to change transmission frequency of a base station from an initial frequency to a second frequency; and sending a message to a blockchain authenticator, wherein the message indicates the second frequency.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system for blockchain authentication and cybersecurity.

FIG. 2 illustrates an exemplary method for blockchain authentication and cybersecurity.

FIG. 3 illustrates exemplary blockchain records.

FIG. 4 illustrates a schematic of an exemplary network device.

FIG. 5 illustrates an exemplary communication system that provides wireless telecommunication services over wireless communication networks.

### DETAILED DESCRIPTION

The CBRS system instructs a spectrum access sharing (SAS) entity when an environmental event has occurred (e.g., a radar is active) and instructs the cell sites in the vicinity to change frequencies. When this occurs, there is no permanent record that a frequency change was instructed. Furthermore, the cell sites connected to the SAS trust that the frequency change is valid and have no permanent record of who ordered the RF change, for what reason, and whether this was a valid entity. While there are logs kept, the records are not secure and could be easily modified. This may present a security risk depending on your perspective. For some use cases, the requested frequency change may expose recipients of malicious third-party actors with significant repercussions.

A set of new network element functions and associated processes are disclosed which may utilize blockchain technology to authenticate and permanently log changes to RF changes originating from an entity, such as a SAS server.

Disclosed herein is the use of blockchain algorithms to authenticate frequency changes and create a near permanent log of when DSS frequencies were modified. This approach allows for a secure and not readily changeable log that can detail the history of when frequencies were changed by the frequency owner or a delegated third party to perform spectrum access sharing (SAS) services or the like. This may be especially relevant since over the next 5 years more frequencies currently owned by the Department of Defense are expected to be released to the public and used via dynamic spectrum sharing (DSS) facilities. The addition of secure authentication and logging services may enhance the confidence in frequency allocation decisions and improve the commercialization of these services. Various offers may be introduced to manage the blockchain authentication process and position itself in a controlling or monetization posture.

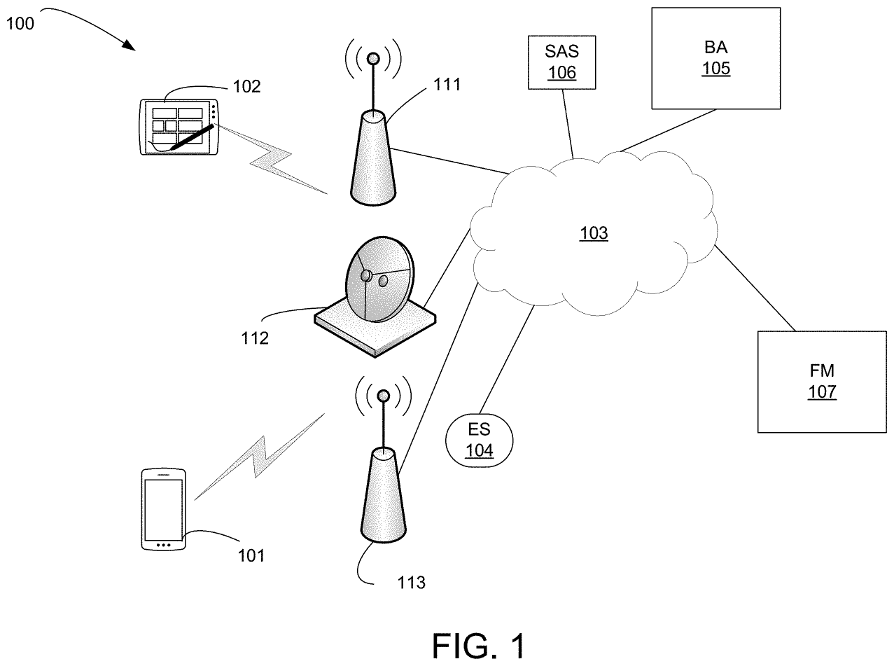

FIG. 1 illustrates an exemplary system to secure a network. System 100 may include network 103. Mobile device 101, mobile device 102, base station 111, base station 112, base station 113, environmental sensor (ES) 104, SAS 106, blockchain authenticator (BA) 105, or frequency manager (FM) 107 may be communicatively connected with each other via network 103. Network 103 may include vRouters, access points, DNS servers, firewalls, or the like (virtual or physical entities). Mobile device 101 or mobile device 102 may be able to communicate with a respective base station using multiple frequencies (e.g., a first frequency range which may be different from a second frequency range).

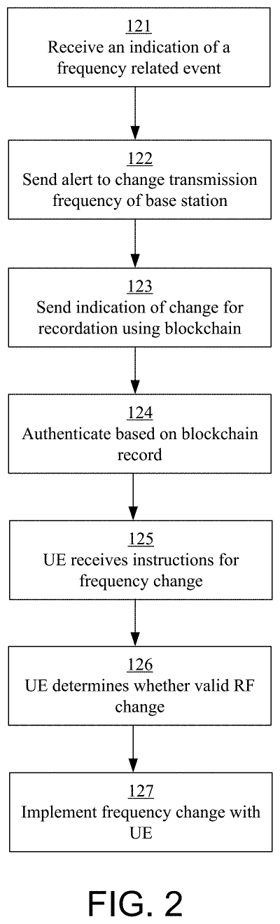

FIG. 2 illustrates an exemplary method to secure a network using blockchain.

At step 121, a device (e.g., SAS 106) may receive an indication of an event (e.g., environment sensing event). The event may include detection of radio waves active in a first frequency. For example, an event may include base station 112 (e.g., a military radar device) activated in a specific frequency in a geographic area. The geographic area may include one or more base stations (e.g., base station 111 or base station 113) and connected wireless communication devices (e.g., mobile phone 101 or mobile phone 102). Sensor 104 or the like may detect the event and send the information to the spectrum access sharing (SAS) system 106.

At step 122, in response to the event, providing instructions to change transmission frequency of base station 113 (or other base stations in the geographic area) from an initial frequency to a second frequency. It is also contemplated that the UEs frequency will be changed (e.g., base station sends info to trigger change). For example, the SAS system 106 may send a message to blockchain authenticator (BA) 105 indicating an authorized frequency change. BA 105 may be a virtual network function. BA 105 may reside within the carrier premises or outside the carrier in a cloud infrastructure implementation model. BA 105 may have the private keys of some or all of the cell sites that will support an RF change. For example, a carrier may have 100 cell sites that support the CBRS 3.5 GHz spectrum.

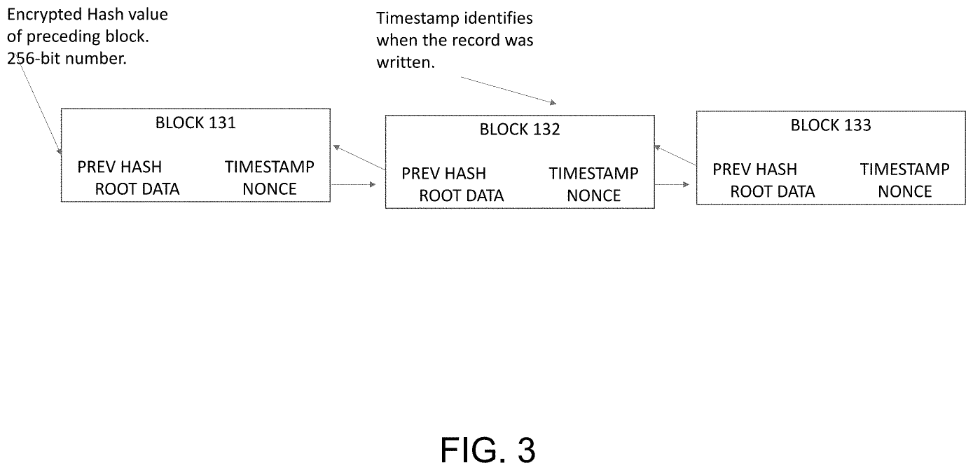

At step 123, sending a message to BA 105 or local frequency manager (LFM) 107. The message may indicate the second frequency. BA 105 or LFM 107 may generate a blockchain record indicating the change to the second frequency. The blockchain record may be stored by BA 105 or LFM 107. FIG. 3 provides an example of blockchain records (e.g., block 131, block 132, or block 133).

At step 124, BA 105 may communicate a frequency change to the second frequency with LFM 107 using keys. In an example scenario, each one of the cell sites may have a private and public key combination residing on LFM 107. LFM 107 may be a new module/VNF that resides on the cell site. In the communication between BA 105 and LFM 107, there may be a hash value of previous blocks communicated. The hash value may be one or more previous blockchain records. In an example, the hash value may be of two previous sequential records or records in a nonsequential order. LFM 107 may authenticate using the hash values before providing instructions to base station 113 for the change to the second frequency.

At step 125, UE 101 may receive an instruction (e.g., from base station 113) to implement the frequency change.

At step 126, UE 101 may determine whether or not the RF change is valid and authorized based on the blockchain record in LFM. UE 101 may be able to check the blockchain record in order to determine whether or not the RF change is valid and authorized.

At step 127, UE 101 may implement frequency change based on the determination of step 125.

UE 101 may have a systems module that supports blockchain authentication and validation. UE 101 may be capable of using the ledger of the blockchain to validate blockchain transactions in order to ensure that the RF change is valid, and someone is not trying to hijack the session. The ledger of LFM 107 keeps a near permanent and near unchangeable record of each change. BA 105 may communicate with other blockchain authenticators inside the carrier network or external to the carrier network.

It is contemplated herein that the functions disclosed may operate within one device (e.g., a server) or multiple devices (e.g., multiple servers, base stations, or mobile devices).

Using blockchain to authenticate RF changes may enable carriers and enterprises to create a permanent record of frequency modifications. These new systems may enable security or validation capabilities that may enhance the cybersecurity of radio frequency networks, which may be particularly useful when dynamic spectrum sharing is implemented.

In addition, this system may allow for monetization associated with validation and cybersecurity of devices operating in a dynamic spectrum sharing environment. For example, cybersecurity services associated with the disclosed blockchain system may be sold. UE 101 may be capable of using blockchain to validate blockchain transactions in order to ensure that the RF change is valid or someone is not trying to hijack the session.

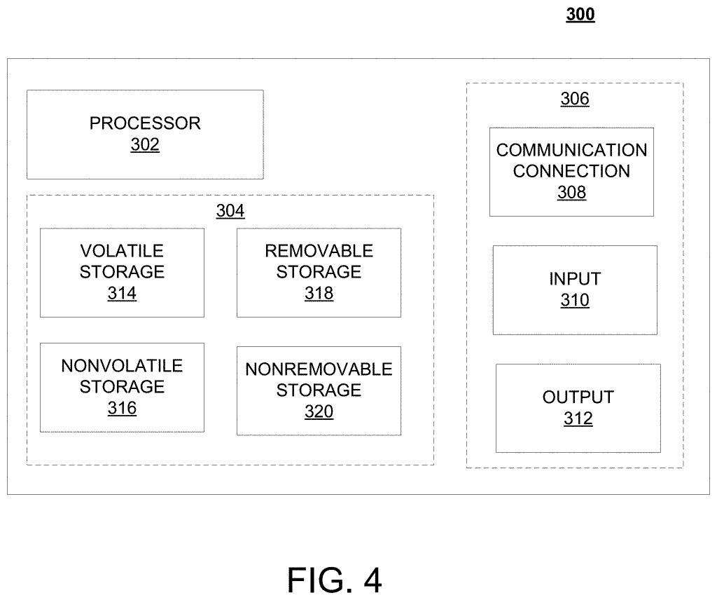

FIG. 4 is a block diagram of network device 300 that may be connected to or comprise a component of system 100. Network device 300 may comprise hardware or a combination of hardware and software. The functionality to facilitate telecommunications via a telecommunications network may reside in one or combination of network devices 300. Network device 300 depicted in FIG. 4 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 4 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 4) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

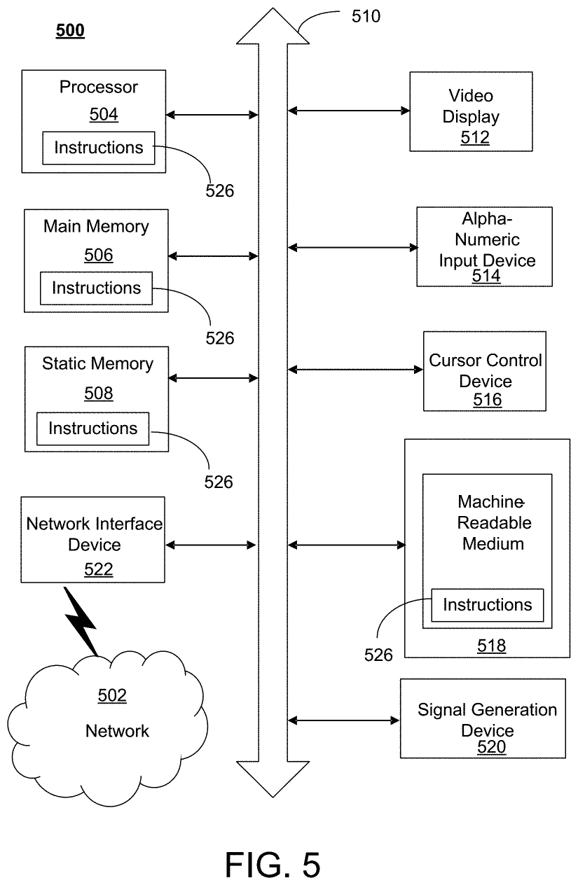

FIG. 5 depicts an exemplary diagrammatic representation of a machine in the form of a computer system 500 within which a set of instructions, when executed, may cause the machine to perform any one or more of the methods described above. One or more instances of the machine can operate, for example, as processor 302, Mobile device 101, mobile device 102, base station 111 (e.g., eNB or gNB), base station 112, base station 113, environmental sensor (ES) 104, SAS 106, blockchain authenticator (BA) 105, or frequency manager (FM) 107 (there may be a local frequency manager or other devices of FIG. 1. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a system in which blockchain messages can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—blockchain authentication and cybersecurity—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for managing blockchain authentication and cybersecurity. A method, system, computer readable storage medium, or apparatus provides for: receiving an indication of an event, wherein in the event comprises detection of radio waves (e.g., military radar) active in a first frequency; based on the event, providing instructions to change transmission frequency of a base station from an initial frequency to a second frequency; sending a message to a blockchain authenticator, wherein the message indicates the second frequency, wherein the blockchain authenticator generates a blockchain record indicating the change to the second frequency, the blockchain record stored by a local frequency manager (LFM) of the base station; UE receives the blockchain record; UE determines whether or not the RF change is valid and authorized based on the blockchain record in LFM. All combinations in this paragraph (including the removal or addition of steps) are contemplated in a manner that is consistent with the other portions of the detailed description.

What is claimed:

1. A method comprising:
receiving an indication of an event, wherein in the event comprises detection of radio waves active in a first frequency;
based on the event, providing instructions to change transmission frequency of a base station from an initial frequency to a second frequency; and
sending a message to a blockchain authenticator, wherein the message indicates the second frequency.

2. The method of claim 1, wherein the blockchain authenticator generates a blockchain record indicating the change to the second frequency.

3. The method of claim 1, wherein the blockchain authenticator generates a blockchain record indicating the change to the second frequency, the blockchain record stored by a local frequency manager (LFM) of the base station.

4. The method of claim 1, the operations further comprising determining whether or not the radio frequency (RF) change is valid and authorized based on the blockchain record in local frequency manager (LFM) of the base station.

5. The method of claim 1, wherein the first frequency is associated with military radar.

6. The method of claim 1, wherein the first frequency is within a range of 3.5 Ghz-3.7 Ghz.

7. The method of claim 1, wherein the block chain authenticator is a virtual network function.

8. A system comprising:
one or more processors; and
memory coupled with the one or more processors, the memory storing executable instructions that when executed by the one or more processors cause the one or more processors to effectuate operations comprising:
receiving an indication of an event, wherein in the event comprises detection of radio waves active in a first frequency;
based on the event, providing instructions to change transmission frequency of a base station from an initial frequency to a second frequency; and
sending a message to a blockchain authenticator, wherein the message indicates the second frequency.

9. The system of claim 8, wherein the blockchain authenticator generates a blockchain record indicating the change to the second frequency.

10. The system of claim 8, wherein the blockchain authenticator generates a blockchain record indicating the change to the second frequency, the blockchain record stored by a local frequency manager (LFM) of the base station.

11. The system of claim 8, the operations further comprising determining whether or not the radio frequency (RF) change is valid and authorized based on the blockchain record in local frequency manager (LFM) of the base station.

12. The system of claim 8, wherein the first frequency is associated with military radar.

13. The system of claim 8, wherein the first frequency is within a range of 3.5 Ghz-3.7 Ghz.

14. The system of claim 8, wherein the block chain authenticator is a virtual network function.

15. A computer readable storage medium storing computer executable instructions that when executed by a computing device cause said computing device to effectuate operations comprising:
receiving an indication of an event, wherein in the event comprises detection of radio waves active in a first frequency;
based on the event, providing instructions to change transmission frequency of a base station from an initial frequency to a second frequency; and
sending a message to a blockchain authenticator, wherein the message indicates the second frequency.

16. The computer readable storage medium of claim 15, wherein the blockchain authenticator generates a blockchain record indicating the change to the second frequency.

17. The computer readable storage medium of claim 15, wherein the blockchain authenticator generates a blockchain record indicating the change to the second frequency, the blockchain record stored by a local frequency manager (LFM) of the base station.

18. The computer readable storage medium of claim 15, the operations further comprising determining whether or not the radio frequency (RF) change is valid and authorized based on the blockchain record in local frequency manager (LFM) of the base station.

19. The computer readable storage medium of claim 15, wherein the first frequency is associated with military radar.

20. The computer readable storage medium of claim 15, wherein the block chain authenticator is a virtual network function.
